(19) United States
(12) Patent Application Publication
(10) Pub. No.: US 2016/0255452 A1
(43) Pub. Date: Sep. 1, 2016

(54) METHOD AND APPARATUS FOR COMPRESSING AND DECOMPRESSING SOUND FIELD DATA OF AN AREA

(71) Applicants: Fraunhofer-Gesellschaft zur Foerderung der angewandten Forschung e.V., Muenchen (DE); Technische Universitaet IImenau, IImenau (DE)

(72) Inventors: Johannes Nowak, Erfurt (DE); Christoph Sladeczek, IImenau (DE)

(73) Assignees: Fraunhofer-Gesellschaft zur Foerderung der angewandten Forschung e.V., Muenchen (DE); Technische Universitaet IImenau, IImenau (DE)

(21) Appl. No.: 15/154,189

(22) Filed: May 13, 2016

Related U.S. Application Data
(63) Continuation of application No. PCT/EP2014/073808, filed on Nov. 5, 2014.

(30) Foreign Application Priority Data
Nov. 14, 2013 (DE) 10 2013 223 201.2
Nov. 5, 2014 (EP) PCT/EP2014/073808

(51) Int. Cl. H04S 3/00; G10L 19/02

(52) U.S. Cl. CPC H04S 3/008; G10L 19/0212; G10L 19/0208; H04S 2420/11; H04S 2420/01

(57) ABSTRACT

An apparatus for compressing sound field data of an area includes a divider for dividing the sound field data into a first portion and into a second portion, and a converter for converting the first portion and the second portion into harmonic components, wherein the converter is configured to convert the second portion into one or several harmonic components of a second order, and to convert the first portion into harmonic components of a first order, wherein the first order is higher than the second order, to obtain the compressed sound field data.

### CROSS-REFERENCE TO RELATED APPLICATIONS

This application is a continuation of copending International Application No. PCT/EP2014/073808, filed Nov. 5, 2014, which is incorporated herein by reference in its entirety, and additionally claims priority from German Application No. DE 10 2013 223 201.2, filed Nov. 14, 2013, which is also incorporated herein by reference in its entirety.

### BACKGROUND OF THE INVENTION

The present invention relates to audio technology and in particular to compressing spatial sound field data.

The acoustic description of rooms is of high interest for controlling replay arrangements in the form of, for example, headphones, a loudspeaker arrangement having, e.g., two up to an average number of loudspeakers, such as 10 loudspeakers or also for loudspeaker arrangements having a greater number of loudspeakers as they are used in wave field synthesis (WFS).

For spatial audio encoding in general, different approaches exist. One approach is, for example, to generate different channels for different loudspeakers at predefined loudspeaker positions as it is, for example, the case in MPEG surround. Thereby, a listener positioned in a reproduction room at a specific and optimally the central position gets a sense of space for the reproduced sound field.

An alternative description of the space or room is to describe a room by its impulse response. For example, if a sound source is positioned anywhere within a room or area, this room or area can be measured with a circular array of microphones in the case of a two-dimensional area or with an omnidirectional microphone array in the case of a three-dimensional area. For example, if an omnidirectional microphone array having a great number of microphones is considered, such as 350 microphones, measuring the room will be performed as follows. An impulse is generated at a specific position inside or outside the microphone array. Then, each microphone measures the response to this impulse, i.e., the input response. Depending on how strong the reverberation characteristics are, a longer or shorter impulse response will be measured. In this way, as regards to the order of magnitude, measurements in large churches have shown, for example, that impulse responses can last for more than 10 s.

Such a set of, e.g., 350 impulse responses describes the sound characteristic of this room for the specific position of a sound source where the impulse has been generated. In other words, this set of impulse responses represents sound fields data of the area, exactly for the case where a source is positioned at the position where the impulse has been generated. In order to measure the room further, i.e., in order to sense the sound characteristics of the room when a source is positioned at another position, the presented procedure has to be repeated for every further position, e.g., outside the array (but also within the array). For example, if a music hall is to be sensed as regards to the sound field when, e.g., a quartet of musicians is playing, where the individual musicians are located at four different positions, 350 impulse responses are measured for each of the four positions in the above example and these 4×350=1400 impulse responses then represent the sound field data of the area.

Since the time duration of the impulse responses can take on enormous values and then a more detailed representation of the sound characteristics of the room with regard to not only four but even more positions might be desirable, a huge amount of impulse response data results, in particular when it is considered that the impulse responses can indeed take on lengths of more than 10 s.

Approaches for spatial audio encoding are, e.g., spatial audio coding (SAC) [1] or spatial audio object coding (SAOC) [2] allowing bit rate efficient encoding of multichannel audio signals or object-based spatial audio scenes. Spatial impulse response rendering (SIRR) [3] and the further development directional audio coding (DirAc) [4] are parametric encoding methods and are based on a time-dependent estimation of the direction of arrival (DOA) of sound, as well as an estimation of the diffuseness within frequency bands. Here, a separation is made between non-diffuse and diffuse sound field. [5] deals with lossless compression of omnidirectional microphone array data and encoding of higher order ambisonics signals. Compression is obtained by using redundant data between the channels (interchannel redundancy).

Examinations in [6] show a separate consideration of early and late sound fields in binaural reproduction. For dynamic systems where head movements are considered the filter length is optimized by convolving only the early sound field in real time. For the late sound field, merely one filter is sufficient for all directions without reducing the perceived quality. In [7], head-related transfer functions [HRTF) are represented on a sphere in a spherical harmonic range. The influence of different accuracies by means of different orders of spherical harmonics on the interaural cross-correlation and the spatio-temporal correlation is analytically examined. This takes place in octave bands in the diffuse sound field.
[1] Herre, J et al (2004) Spatial Audio Coding: Next-generation efficient and compatible coding of multi-channel audio AES Convention Paper 6186 presented at the 117th Convention, San Francisco, USA
[2] Engdegard, J et al (2008) Spatial Audio Object Coding (SAOC) —The Upcoming MPEG Standard on Parametric Object Based Audio Coding, AES Convention Paper 7377 presented at the 125th Convention, Amsterdam, Netherlands
[3] Merimaa J and Pulkki V (2003) Perceptually-based processing of directional room responses for multichannel loudspeaker reproduction, IEEE Workshop on Applications of Signal Processing to Audio and Acoustics
[4] Pulkki, V (2007) Spatial Sound Reproduction with Directional Audio Coding, J. Audio Eng. Soc., Vol. 55. No. 6
[5] Hellerud E et al (2008) Encoding Higher Order Ambisonics with AAC AES Convention Paper 7366 presented at the 125th Convention, Amsterdam, Netherlands
[6] Liindau A, Kosanke L, Weinzierl S (2010) Perceptual evaluation of physical predictors of the mixing time in binaural room impulse responses AES Convention Paper presented at the 128th Convention, London, UK
[7] Avni, A and Rafaely B (2009) Interaural cross correlation and spatial correlation in a sound field represented by spherical harmonics in Ambisonics Symposium 2009, Graz, Austria

An encoder-decoder scheme for low bit rates is described in [8]. The encoder generates a composite audio information signal, which describes the sound field to be reproduced, and a direction vector or steering control signal. The spectrum is decomposed in subbands. For controlling, the dominant direction is evaluated in each subband. Based on the perceived spatial audio scene, [9] describes a spatial audio encoder framework in the frequency domain. Temporal frequency dependent direction vectors describe the input audio scene.

[10] describes a parametric channel-based audio encoding method in the time and frequency domain. [11] describes binaural-cue-coding (BCC) using one or several object-based cue codes. The same include direction, width and envelope of an auditory scene. [12] relates to processing spherical array data for reproduction by means of ambisonics. Thereby, the distortions of the system by measurement errors, such as noise, are to be equalized. In [13], a channel-based encoding method is described, which also relates to positions of the loudspeakers as well as individual audio objects. In [14], a matrix-based encoding method is presented, which allows real time transmission of higher order ambisonics sound fields of an order higher than 3.

In [15], a method for encoding spatial audio data is described, which is independent of the reproduction system. Thereby, the input material is divided into two groups, the first of which includes audio necessitating high localizability, while the second group is described with ambisonics orders sufficiently low for localization. In the first group, the signal is encoded in a set of monochannels with metadata. The metadata include time information when the respective channel is to be reproduced and direction information for any moment. In reproduction, the audio channels are decoded for conventional panning algorithms, wherein the reproduction system has to be known. The audio in the second group is encoded in channels of different ambisonics orders. During decoding, ambisonics orders corresponding to the reproduction system are used.
[8] Dolby R M (1999) Low-bit-rate spatial coding method and system, EP 1677576 A3
[9] Goodwin M and Jot J-M (2007) Spatial audio coding based on universal spatial cues, U.S. Pat. No. 8,379,868 B2
[10] Seefeldt A and Vinton M (2006) Controlling spatial audio coding parameters as a function of auditory events, EP 2296142 A2
[11] Faller C (2005) Parametric coding of spatial audio with object-based side information, U.S. Pat. No. 8,340,306 B2
[12] Kordon S, Batke J-M, Kruger A (2011) Method and apparatus for processing signals of a spherical microphone array on a rigid sphere used for generating an ambisonics representation of the sound field, EP 2592845 A1
[13] Corteel E and Rosenthal M (2011) Method and device for enhanced sound field reproduction of spatially encoded audio input signals, EP 2609759 A1
[14] Abeling S et al (2010) Method and apparatus for generating and for decoding sound field data including ambisonics sound field data of an order higher than three, EP 2451196 A1
[15] Arumi P and Sole A (2008) Method and apparatus for three-dimensional acoustic field encoding and optimal reconstruction, EP 2205007 A1

### SUMMARY

According to an embodiment, an apparatus for compressing sound field data of an area may have: a divider for dividing the sound field data into a first portion and into a second portion; and a converter for converting the first portion and the second portion into harmonic components, wherein the converter is configured to convert the second portion into one or several harmonic components of a second order, and to convert the first portion into harmonic components of a first order, wherein the first order is higher than the second order, to obtain the compressed sound field data, wherein the divider is configured to perform spectral division and includes a filterbank for filtering at least part of the sound field data for obtaining sound field data in different filterbank channels, and wherein the converter is configured to compute, for a subband signal from a first filterbank channel, which represents the first portion, of the different filterbank channels, the harmonic components of the first order, and to compute, for a subband signal from a second filterbank channel, which represents the second portion, of the different filterbank channels, the harmonic components of the second order, wherein a center frequency of the first filterbank channel is higher than a center frequency of the second filterbank channel.

According to another embodiment, an apparatus for decompressing compressed sound field data having first harmonic components up to a first order and one or several second harmonic components up to a second order, wherein the first order is higher than the second order, may have: an input interface for obtaining the compressed sound field data; and a processor for processing the first harmonic components and the second harmonic components by using a combination of the first and the second portion and by using a conversion of a harmonic component representation into a time domain representation to obtain a decompressed illustration, wherein the first portion is represented by the first harmonic components and the second portion by the second harmonic components, wherein the first harmonic components of the first order represent a first spectral domain, and the one or the several harmonic components of the second order represent a different spectral domain, wherein the processor is configured to convert the harmonic components of the first order into the spectral domain and to convert the one or the several second harmonic components of the second order into the spectral domain, and to combine the converted harmonic components by means of a synthesis filterbank to obtain a representation of sound field data in the time domain.

According to another embodiment, a method for compressing sound field data of an area may have the steps of: dividing the sound field data into a first portion and into a second portion, and converting the first portion and the second portion into harmonic components, wherein the second portion is converted into one or several harmonic components of a second order, and wherein the first portion is converted into harmonic components of a first order, wherein the first order is higher than the second order, to obtain the compressed sound field data, wherein dividing includes spectral division by filtering with a filterbank for filtering at least part of the sound field data for obtaining sound field data in different filterbank channels, and wherein converting represents a computation of the harmonic components of the first order for a subband signal from a first filterbank channel, which represents the first portion, of the different filterbank channels, and a computation of the harmonic components of the second order for a subband signal from a second filterbank channel, which represents the second portion, of the different filterbank channels, wherein a center frequency of the first filterbank channel is higher than a center frequency of the second filterbank channel.

According to another embodiment, a method for decompressing compressed sound field data including first harmonic components up to a first order and one or several second harmonic components up to a second order, wherein the first order is higher than the second order, may have the steps of: obtaining the compressed sound field data; and processing the first harmonic components and the second harmonic components by using a combination of the first and second portions and by using a conversion from a harmonic component representation into a time domain representation to obtain a decompressed representation, wherein the first portion is represented by the first harmonic components and the second portion by the second harmonic components, wherein the first harmonic components of the first order represent a first spectral domain, and the one or the several harmonic components of the second order represent a different spectral domain, wherein processing includes converting the first harmonic components of the first order into the spectral domain and converting the one or the several second harmonic components of the second order into the spectral domain and combining the converted harmonic components by means of a synthesis filterbank to obtain a representation of sound field data in the time domain.

Another embodiment may have a non-transitory digital storage medium having a computer program stored thereon to perform the method for compressing sound field data of an area, the method having the steps of: dividing the sound field data into a first portion and into a second portion, and converting the first portion and the second portion into harmonic components, wherein the second portion is converted into one or several harmonic components of a second order, and wherein the first portion is converted into harmonic components of a first order, wherein the first order is higher than the second order, to obtain the compressed sound field data, wherein dividing includes spectral division by filtering with a filterbank for filtering at least part of the sound field data for obtaining sound field data in different filterbank channels, and wherein converting represents a computation of the harmonic components of the first order for a subband signal from a first filterbank channel, which represents the first portion, of the different filterbank channels, and a computation of the harmonic components of the second order for a subband signal from a second filterbank channel, which represents the second portion, of the different filterbank channels, wherein a center frequency of the first filterbank channel is higher than a center frequency of the second filterbank channel, when said computer program is run by a computer.

Another embodiment may have a non-transitory digital storage medium having a computer program stored thereon to perform the method for decompressing compressed sound field data including first harmonic components up to a first order and one or several second harmonic components up to a second order, wherein the first order is higher than the second order, the method having the steps of: obtaining the compressed sound field data; and processing the first harmonic components and the second harmonic components by using a combination of the first and second portions and by using a conversion from a harmonic component representation into a time domain representation to obtain a decompressed representation, wherein the first portion is represented by the first harmonic components and the second portion by the second harmonic components, wherein the first harmonic components of the first order represent a first spectral domain, and the one or the several harmonic components of the second order represent a different spectral domain, wherein processing includes converting the first harmonic components of the first order into the spectral domain and converting the one or the several second harmonic components of the second order into the spectral domain and combining the converted harmonic components by means of a synthesis filterbank to obtain a representation of sound field data in the time domain, when said computer program is run by a computer.

An apparatus for compressing sound field data of an area includes a divider for dividing the sound field data into a first portion and a second portion as well as a downstream converter for converting the first portion and the second portion in harmonic components, wherein the conversion takes place such that the second number is converted into one or several harmonic components of a second order, and that the first portion is converted into harmonic components of a first order, wherein the first order is higher than the second order, to obtain the compressed sound field data.

Thus, according to the invention, conversion of the sound field data, such as the amount of impulse responses into harmonic components is performed, wherein this conversion can already result in significant data saving. Harmonic components as can be obtained, for example, by means of spatial spectral transformation, describe a sound field in a much more compact manner than impulse responses. Apart from this, the order of harmonic components can easily be controlled. The harmonic component of the zeroth order is merely an (non-directional) mono signal. The same does not allow any sound field directional description. In contrast, the additional harmonic components of the first order already allow a relatively coarse direction representation analogous to beam forming. The harmonic components of the second order allow an additional, even more exact sound field description including even more directional information. In ambisonics, for example, the number of components equals 2n+1, wherein n is the order. For the zeroth order, thus, there is only a single harmonic component. For conversion up to the first order, already three harmonic components exist. For conversion of a fifth order, for example, there are already 11 harmonic components and it has been found out that, for example, for 350 impulse responses an order of 14 is sufficient. In other words, this means that 29 harmonic components describe the room as well as 350 impulse responses. This conversion from a value of 350 input channels to 29 output channels already results in a compression gain. Additionally, according to the invention, a conversion of different portions of the sound field data, such as the impulse responses of different orders is performed, since it has been found out that not all portions have to be described with the same accuracy/order.

One example for this is that the directional perception of the human hearing is mainly derived from the early reflections, while the later/diffuse reflections in a typical impulse response do not contribute anything or only very little to directional perception. Thus, in this example, the first portion will be the early portion of the impulse responses which is converted with a higher order in the harmonic component domain, while the late diffuse portion is converted with a lower order and even partly with an order of zero.

Another example is that the directional perception of the human hearing is frequency dependent. In low frequencies, directional perception of the human hearing is relatively weak. Thus, for compressing sound field data it is sufficient to convert the lower spectral domain of the harmonic components with a relatively low order into the harmonic component domain, while the frequency domains of the sound field data where the directional perception of the human hearing is very high are converted with a high and advantageously even with the maximum order. For this, sound field data can be decomposed into individual subband sound field data by means of a filter bank and these subband sound field data are then decomposed with different orders, wherein again the first portion comprises subband sound field data at higher frequencies, while the second portion comprises subband sound field data at lower frequencies, wherein very low frequencies can also again be represented with an order of zero, i.e., only with a single harmonic component.

In a further example, the advantageous characteristics of temporal and frequency processing are combined. Thus, the early portion, which is converted with a higher order anyway, can be decomposed into spectral components for which then again orders adapted for the individual bands can be obtained. In particular, when a decimating filter bank is used for the subband signals, such as a QMF filterbank (QMF=quadrature mirror filterbank), the effort for converting the subband sound field data into the harmonic component domain is additionally reduced. Above this, differentiation of different portions of the sound field data with respect to the order to be computed provides significant reduction of the computation effort, especially since the computation of the harmonic components, such as the cylindrical harmonic components or the spherical harmonic components strongly depends on up to what order the harmonic components are to be computed. Computing the harmonic components up to the second order, for example, necessitates significantly less computing effort and hence computing time and battery power, respectively, in particular in mobile devices, than a computation of the harmonic components, up to the order of, for example, 14.

In the described embodiments, the converter is hence configured to convert the portion, i.e., the first portion of the sound field data, which is more important for directional perception of the human hearing, with a higher order than the second portion that is less important for directional perception of a sound source than the first portion.

The present invention cannot only be used for temporal decomposition of sound field data into portions or for spectral decomposition of sound field data into portions, but also for an alternative, e.g., spatial decomposition of the portions, when it is taken into account, for example, that the directional perception of human hearing for sound is different in different azimuth or elevation angles. When the sound field data exist, for example, as impulse responses or other sound field descriptions, where a specific azimuth/elevation angle is allocated to each individual description, the sound field data of azimuth/elevation angles where the directional perception of the human hearing is greater can be compressed with a higher order than a spatial portion of the sound field data from another direction.

Alternatively or additionally, the individual harmonics can be “thinned out”, i.e., in the example with order 14, where 29 modes exist. Depending on the human directional perception, individual modes are saved, which map the sound field for irrelevant directions of arrival of sound. In the case of microphone array measurements, there is an uncertainty since it is not known in what direction the head is oriented with respect to the array sphere. However, if HRTFs are represented by means of spherical harmonics, this uncertainty is eliminated.

Further decompositions of the sound field data in addition to decompositions in temporal, spectral or spatial direction can also be used, such as decomposition of the sound field data in a first and second portion in volume classes, etc.

In embodiments, acoustic problems are described in the cylindrical or spherical coordinate system, i.e., by means of complete sets of orthonormal characteristic functions, the so-called cylindrical or spherical harmonic components. With higher spatial accuracy of the description of the sound field, the data volume and the computing time when processing or manipulating the data increases. For high-quality audio applications, high accuracies are necessitated, which results in problems of long computing times that are particularly disadvantageous for real time systems, of great amounts of data that complicate the transmission of spatial sound field data, and of high energy consumption by intensive computation effort, in particular in mobile devices.

All these disadvantages are eased or eliminated by embodiments of the invention in that, due to differentiation of the orders for computing the harmonic components, the computing times are reduced compared to a case where all portions of the highest order are converted in harmonic components. According to the invention, the great amounts of data are reduced in that the representation by harmonic components is, in particular, more compact and that additionally different portions of different orders are still represented, wherein the reduction of the amounts of data is obtained in that a lower order, such as the first order, has only three harmonic components, while the highest order has, for example, 29 harmonic components, here, as an example, an order of 14.

The reduced computing power and the reduced memory consumption automatically reduce the energy consumption which arises in particular for the usage of sound field data in mobile devices.

In embodiments, the spatial sound field description is optimized in a cylindrical or spherical harmonic domain based on the spatial perception of humans. In particular, a combination of time and frequency dependent computation of the order of spherical harmonics in dependence of the spatial perception of the human hearing results in a significant reduction of the effort without reducing the objective quality of the sound field perception. Obviously, the objective quality is reduced, since the present invention represents a lossy compression. This lossy compression is, however, uncritical, especially since the final recipient is the human hearing and, thus, it is even insignificant for transparent reproduction whether sound field components, which are not perceived by human hearing anyway, exist in the reproduced sound field or not.

In other words, during reproduction/auralization either binaurally, i.e., with headphones or with loudspeaker systems having few (e.g., stereo) or many loudspeakers (e.g., WFS), the human hearing is the most important quality criterion. According to the invention, the accuracy of the harmonic components, such as the cylindrical or spherical harmonic is perceptually reduced in the time domain and/or in the frequency domain or in other domains. Thereby, reduction of data and computing time is obtained.

### BRIEF DESCRIPTION OF THE DRAWINGS

Embodiments of the present invention will be detailed subsequently referring to the appended drawings, in which:

FIG. 1a is a block diagram of an apparatus for compressing sound field data according to an embodiment;

FIG. 1b is a block diagram of an apparatus for decompressing compressed sound field data of an area;

FIG. 1c is a block diagram of an apparatus for compressing with temporal decomposition;

FIG. 1d is a block diagram of an embodiment of an apparatus for decompressing for the case of temporal decomposition;

FIG. 1e is an apparatus for decompressing as an alternative to FIG. 1d;

FIG. 1f is an example for applying the invention with temporal and spectral decomposition with exemplary 350 measured impulse responses as sound field data;

FIG. 2a is a block diagram of an apparatus for compressing with spectral decomposition;

FIG. 2b is an example of a subsampled filterbank and a subsequent conversion of the subsampled subband sound field data;

FIG. 2c is an apparatus for decompressing for the example of spectral decomposition shown in FIG. 2a;

FIG. 2d is an alternative implementation of the decompressor for spectral decomposition;

FIG. 3a is an overview block diagram with a specific analysis/synthesis encoder according to a further embodiment of the present invention;

FIG. 3b is a detailed representation of an embodiment with temporal and spectral decomposition;

FIG. 4 is a schematic representation of an impulse response;

FIG. 5 is a block diagram of a converter of time or spectral domain in the harmonic component domain with variable order; and

FIG. 6 is a representation of an exemplary converter of harmonic component domain into the time domain or spectral domain with subsequent auralization.

### DETAILED DESCRIPTION

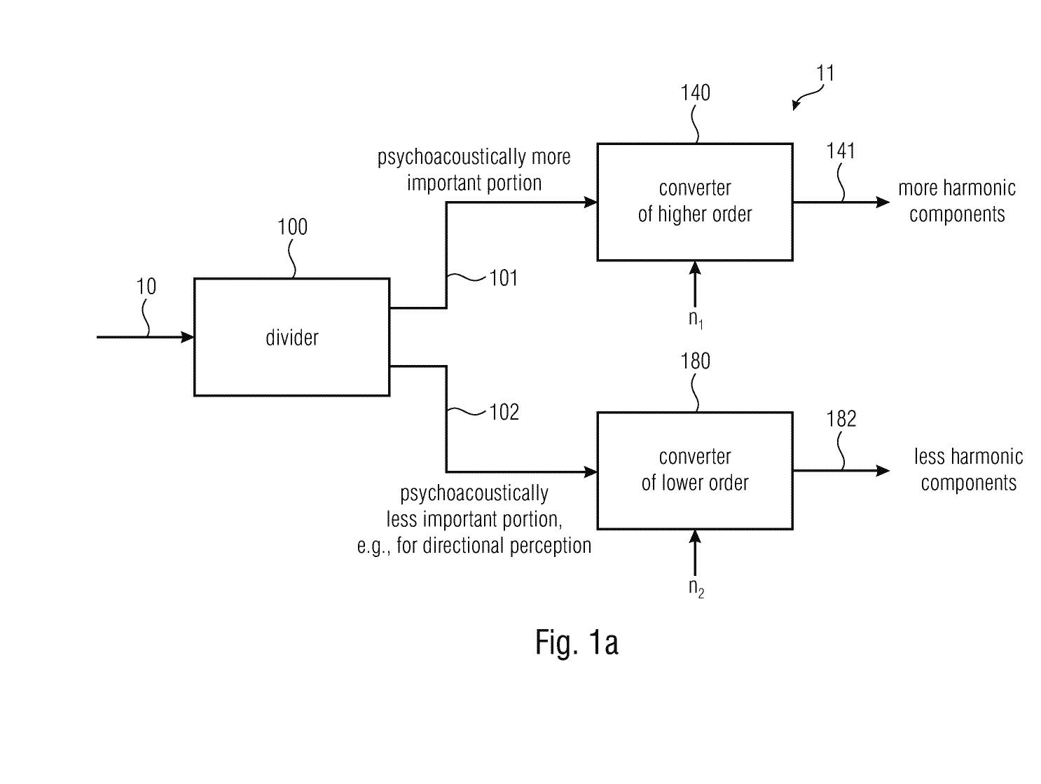

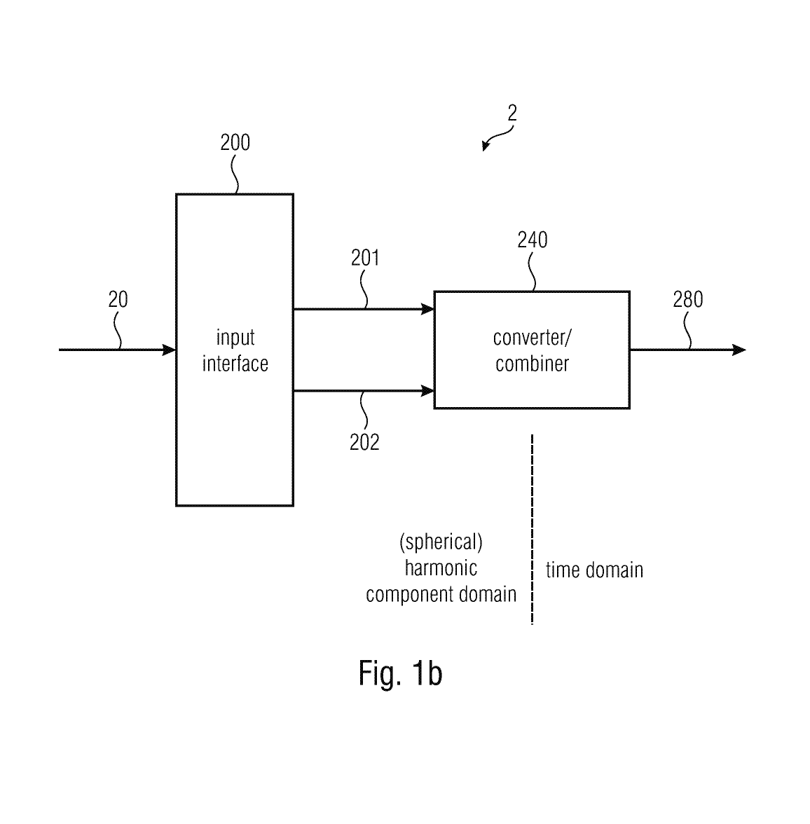

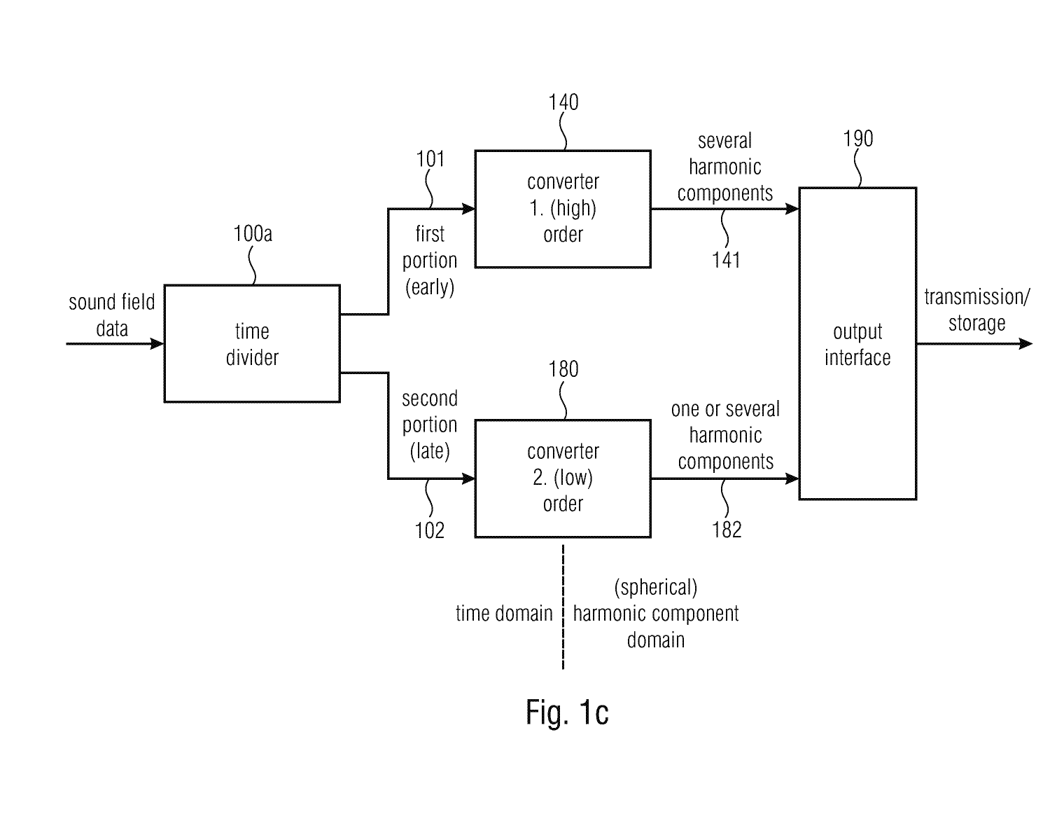

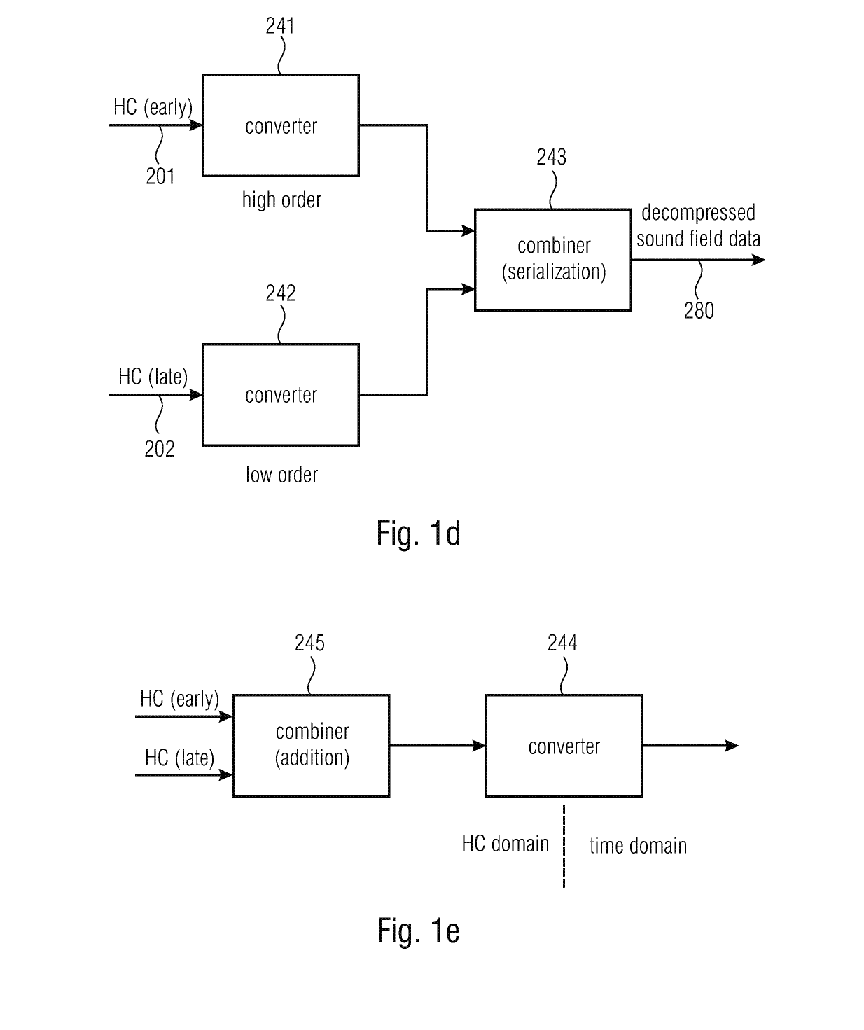

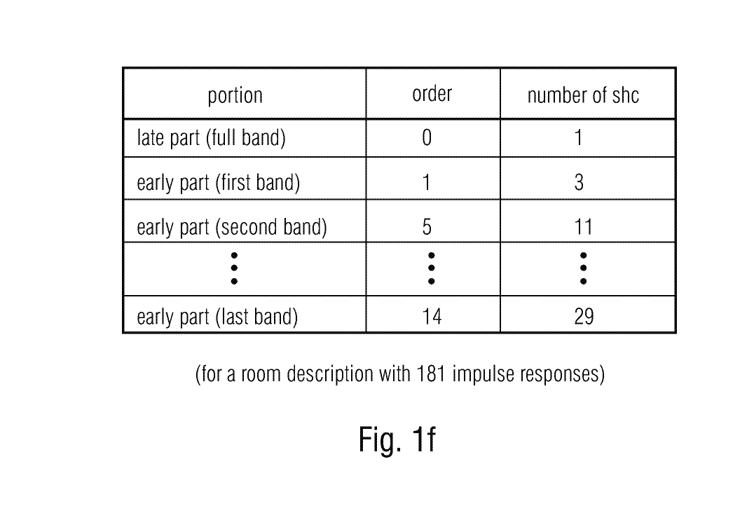

FIG. 1a shows a block diagram of an apparatus or a method for compressing sound field data of an area as they are input into a divider 100 at an input 10. The divider 100 is configured to divide the sound field data into a first portion 101 and a second portion 102. Above this, a converter is provided having the two functionalities indicated by 140 or 180. In particular, the converter is configured to convert the first portion 101 as indicated at 140 and to convert the second portion 102 as indicated at 180. In particular, the converter converts the first portion 101 into one or several harmonic components 141 of a first order, while the converter 180 converts the second portion 102 into one or several harmonic components 182 of a second order. In particular, the first order, i.e., the order underlying the harmonic components 141, is higher than the second order, which means, in other words, that the converter 140 of a higher order outputs more harmonic components 141 than the converter 180 of a lower order. Thus, the order n₁ by which the converter 140 is controlled is higher than the order n₂ by which the converter 180 is controlled. The converters 140, 180 can be controllable converters. Alternatively, the order can be set and hence non-adjustable, such that the inputs indicated by n₁ and n₂ do not exist in this embodiment.

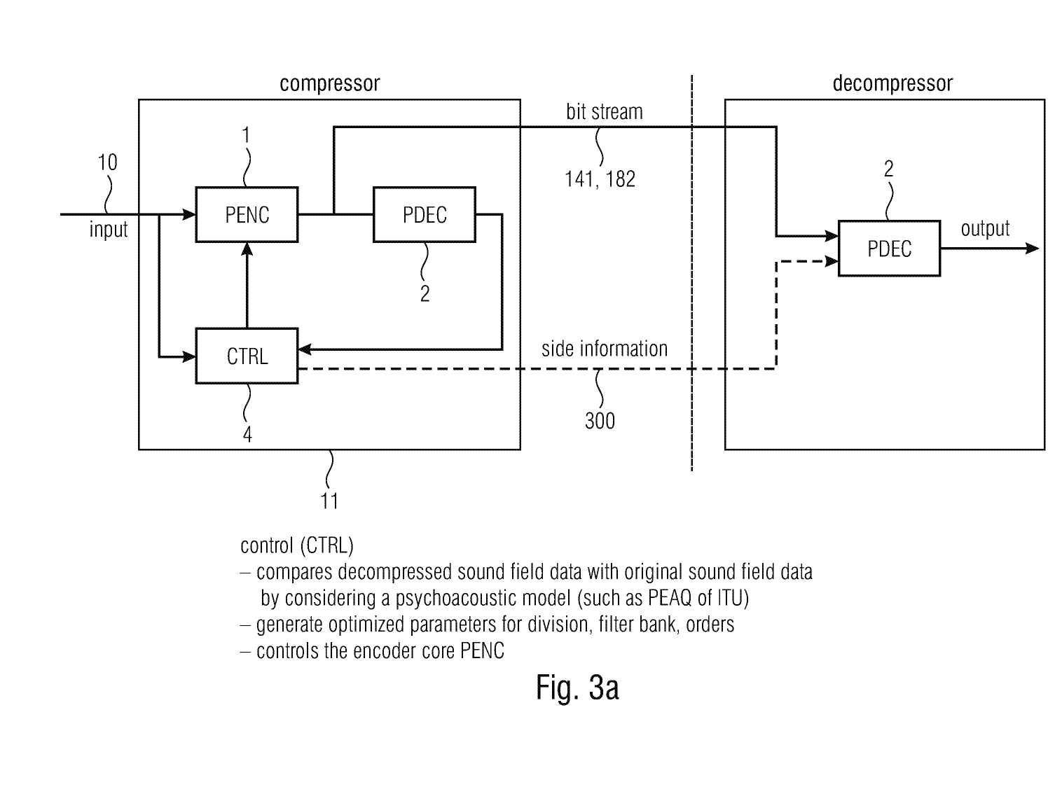

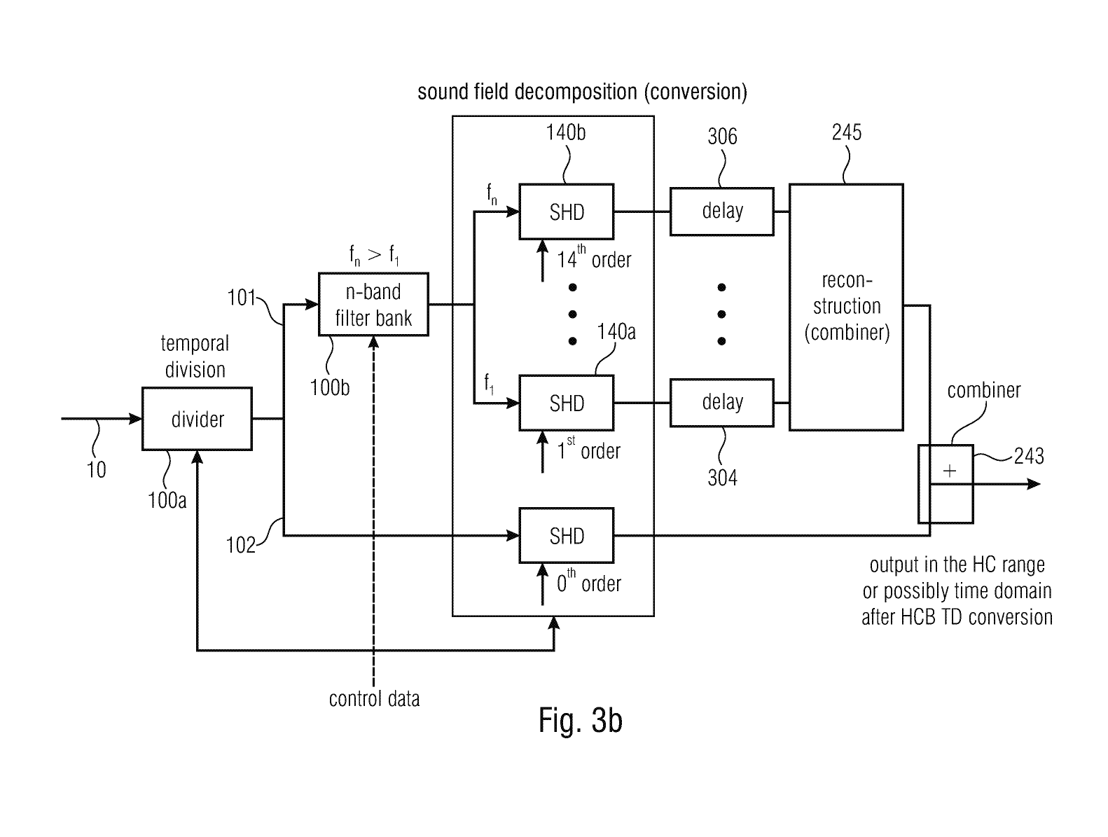

FIG. 1b shows an apparatus for decompressing compressed sound field data 20 comprising a first harmonic component of a first order and one or several harmonic components of a second order, as they are output, for example, by FIG. 1a at 141, 182. However, the decompressed sound field data do not necessarily have to be the harmonic components 141, 142 in “raw format”. Instead, in the FIG. 1a, additionally, a lossless entropy encoder, such as a Huffmann encoder or an arithmetic encoder could be provided in order to further reduce the number of bits that are finally necessitated for representing the harmonic components. The data stream 20 fed into an input interface 200 would then consist of entropy encoded harmonic components and possibly side information, as will be illustrated based on FIG. 3a. In this case, a respective entropy decoder, which is adapted to the entropy encoder on the encoder side, i.e., with respect to FIG. 1a, would be provided at the output of the input interface 200. Thus, the first harmonic components of the first order 201 and the second harmonic components of the second order 202, as illustrated in FIG. 1b, possibly also represent entropy encoded or already entropy decoded or actually the harmonic components in “raw format” as present at 141, 182 in FIG. 1a.

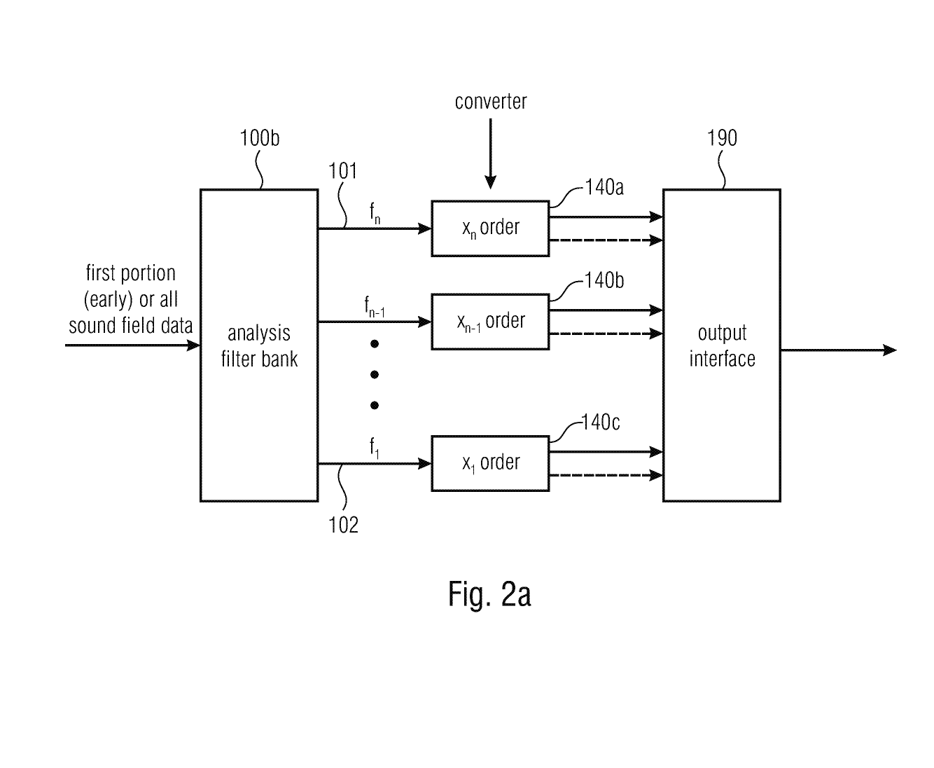

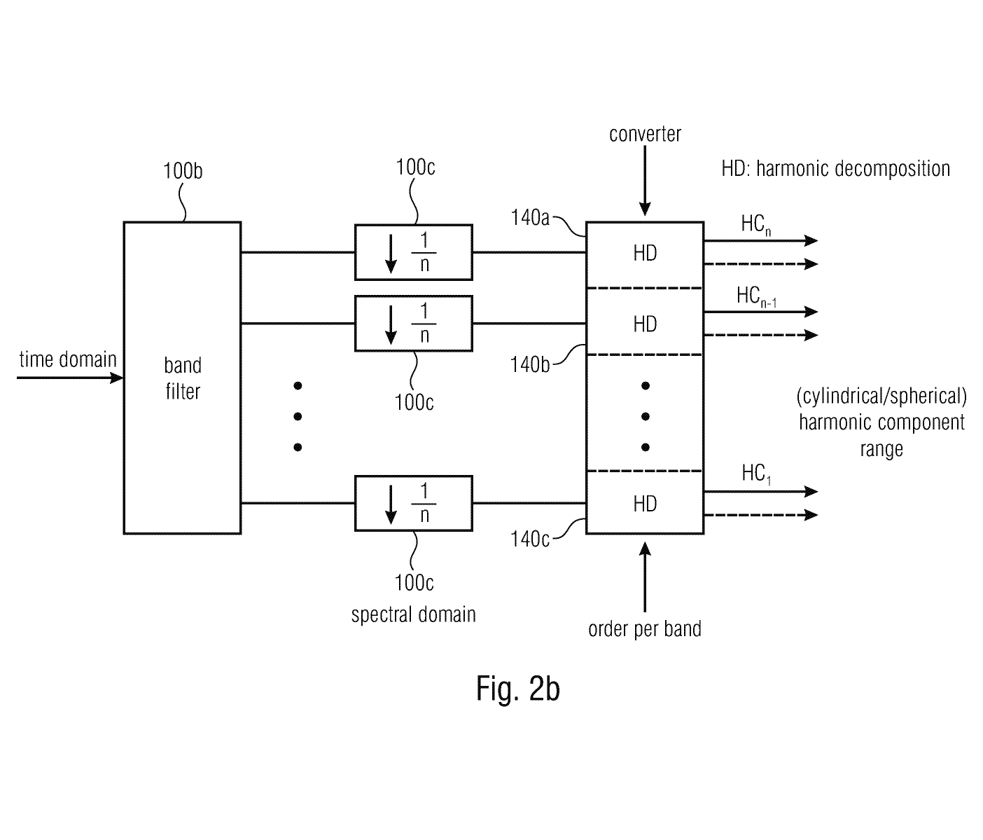

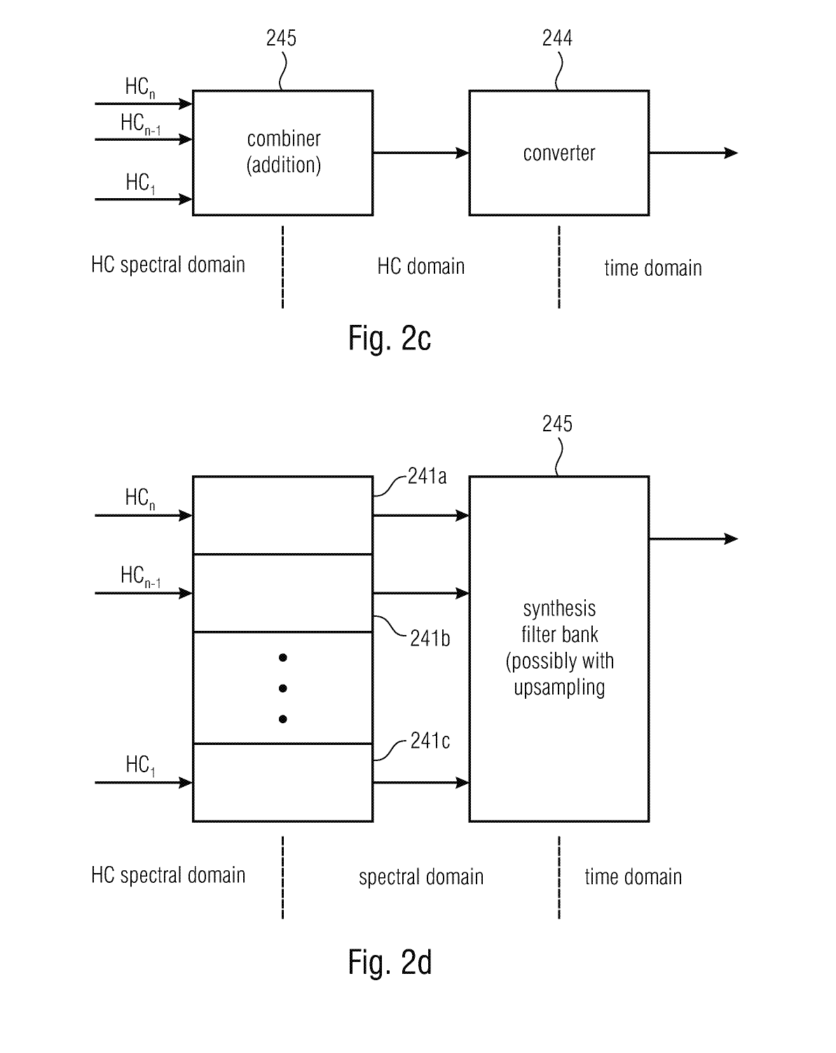

Both groups of harmonic components are fed into a decoder or converter/combiner 240. The block 240 is configured to decompress the compressed sound field data 201, 202 by using a combination of the first portion and the second portion and by using a conversion of a harmonic component representation into a time domain representation in order to finally obtain the decompressed representation of the sound field as illustrated at 240. The decoder 240 which may be configured as a signal processor is hence configured to perform, on the one hand, conversion into the time domain from the spherical harmonic component domain and, on the other hand, to perform a combination. The order between conversion and combination can vary, as illustrated with respect to FIG. 1d, FIG. 1e or FIG. 2c, 2d for different examples.

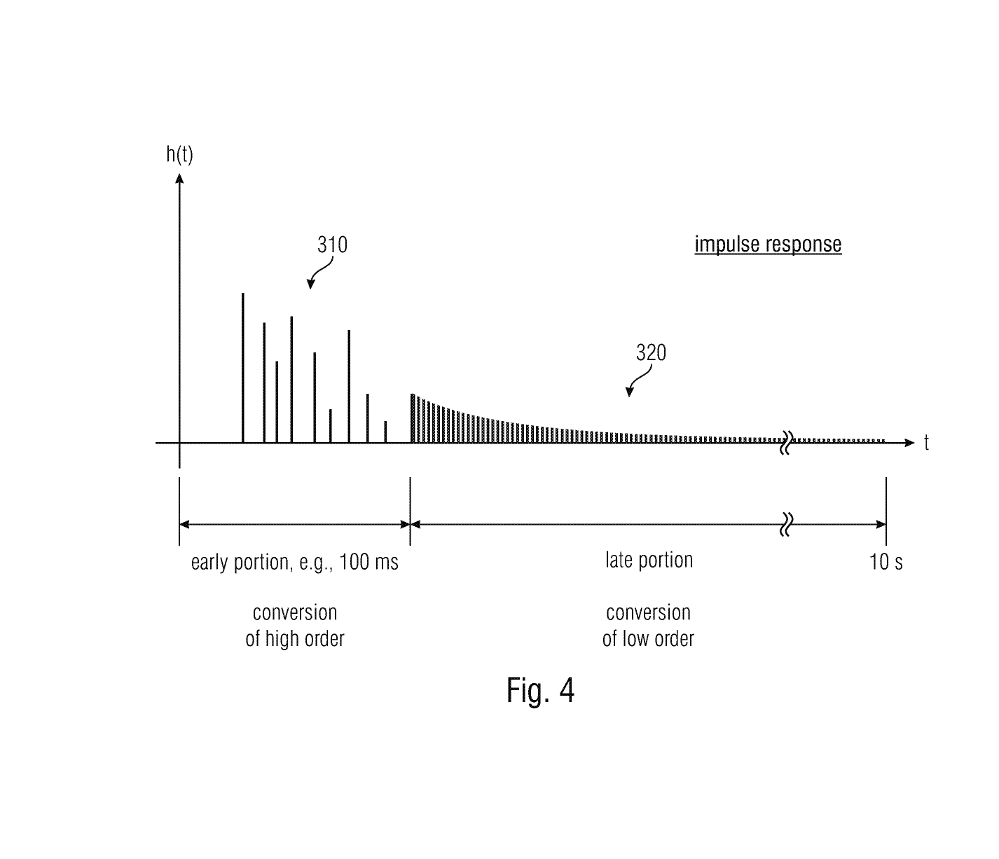

FIG. 1c shows an apparatus for compressing sound field data of an area according to an embodiment where the divider 100 is configured as temporal divider 100a. In particular, the temporal divider 100a which is an implementation of the divider 100 of FIG. 1a is configured to divide the sound field data in a first portion including first reflections in the area and a second portion including second reflections in the area, wherein the second reflections occur later in time than the first reflections. Thus, based on FIG. 4, the first portion 101 output by a block 100a represents the impulse response section 310 of FIG. 4, while the second late portion represents the section 320 of the impulse response of FIG. 4. The time of division, for example, can be at 100 ms. However, different options of time division exist, such as earlier or later. Advantageously, the division is placed where the discrete reflections change to diffuse reflections. Depending on the room this can be a varying point in time and concepts for providing the best division exist. However, the division into an early and a late portion an also be performed based on an available data rate, in that the division time is made smaller and smaller the less bit rate exists. This is favorable with regard to the bit rate, since a portion of the impulse response of a low order, which is as great as possible, is converted into the harmonic component domain.

Thus, the converter illustrated by blocks 140 and 180 in FIG. 1c is configured to convert the first portion 101 and the second portion 102 into harmonic components, wherein the converter in particular converts the second portion into one or several harmonic components 182 of a second order and the first portion 101 into harmonic components 141 of a first order, wherein the first order is higher than the second order, to finally obtain the compressed sound field which can finally be output by the output interface 190 for transmission and/or storage purposes.

FIG. 1d shows an implementation of the decompressor for the example of temporal division. In particular, the decompressor is configured to convert the compressed sound field data by using a combination of the first portion 201 having the first reflections and the second portion 202 having the later reflections and a conversion from the harmonic components domain to the time domain. FIG. 1d shows an implementation where the combination takes place after the conversion. FIG. 1e shows an alternative implementation where the combination takes place prior to the conversion. In particular, the converter 241 is configured to convert harmonic components of the high order into the time domain, while the converter 242 is configured to convert the harmonic components of the lower order into the time domain. With reference to FIG. 4, the output of the converter 241 provides something corresponding to the range 210, while the converter 242 provides something corresponding to the range 320, wherein, however, due to the lossy compression, the sections at the output of the bridge 241, 242 are not identical to the sections 310, 320. In particular, however, at least a perceptual similarity or identity of the section at the output of block 240 to the section 310 of FIG. 4 will exist, while the section at the output of block 242 corresponding to the late portion 320 of the impulse response will show significant differences and hence merely approximately represents the curve of the impulse response. However, these deviations are uncritical for human directional perception, since the human directional perception is anyway hardly or not at all based on the late portion or the diffuse reflections of the impulse response.

FIG. 1e shows an alternative implementation where the decoder comprises first the combiner 245 and subsequently the converter 244. In the embodiment shown in FIG. 1e, the individual harmonic components are added up, whereupon the result of the addition is converted to finally obtain a time domain representation. In contrary to that, in the embodiment in FIG. 1d, a combination will not consist of addition but of serialization in that the output of block 241 will be arranged earlier in time in a decompressed impulse response than the output of block 242, in order to obtain again an impulse response corresponding to FIG. 4 which can then be used for further purposes, such as auralization, i.e. rendering sound signals with the desired spatial impression.

FIG. 2a shows an alternative implementation of the present invention where division in the frequency domain is performed. In particular, the divider 100 of FIG. 1a is implemented as a filter bank in the embodiment of FIG. 2a in order to filter at least part of the sound field data for obtaining sound field data in different filter bank channels 101, 102. In an embodiment where the temporal division of FIG. 1a is not implemented, the filter bank obtains both the early and late portion, while in an alternative embodiment merely the early portion of the sound field data is fed into the filter bank while the later portion is not spectrally decomposed any further.

The converter which can be configured of sub-converters 140a, 140b, 140c is downstream to the analysis filter bank 100b. The converter 140a, 140b, 140c is configured to convert the sound field data in different filter bank channels by using different orders for different filter bank channels in order to obtain one or several harmonic components for each filter bank channel. In particular, the converter is configured to perform a conversion of a first order for a first filter bank channel with a first center frequency and to perform a conversion of a second order for a second filter bank channel with a second center frequency, wherein the first order is higher than the second order, and wherein the first center frequency, i.e., fₙ, is higher than the second center frequency f₁ in order to finally obtain the compressed sound field representation. Generally, depending on the embodiment, for the lowest frequency band, a lower order can be used than for a center frequency band. However, depending on the implementation, the highest frequency band, as the filter bank channel with the center frequency fₙ in the embodiment shown in FIG. 2a, does not necessarily have to be converted with a higher order than, e.g., a center channel. Instead, in the areas where the directional perception is highest, the highest order can be used, while in the other areas, part of which can also be a certain high frequency domain, the order is lower, since in these areas the directional perception of the human hearing is also lower.

FIG. 2b shows a detailed implementation of the analysis filter bank 100b. The same includes, in the embodiment shown in FIG. 2b, a band filter and further comprises downstream decimators 100c for each filter bank channel. For example, if a filter bank consisting of band filter and decimators is used, which has 64 channels, each decimator can decimate with a factor 1/64, such that, all in all, the number of digital samples at the output of the decimators added up across all channels corresponds to the number of samples of a block of the sound field data in the time domain, which has been decomposed by the filter bank. An exemplary filter bank can be a real or complex QMF filter bank. Each subband signal, advantageously of the early portions of the impulse responses, is then converted into harmonic components by means of the converters 140a to 140c, analogous to FIG. 2a, to finally obtain, for different subband signals of the sound field description, a description with cylindrical or spherical harmonic components, which comprises different orders, i.e., a different number of harmonic components, for different subband signals.

FIG. 2c and FIG. 2d again show different implementations of the decompressor, as illustrated in FIG. 1b, i.e., a different order of the combination and subsequent conversion in FIG. 2c or the conversion performed first and the subsequent combination as illustrated in FIG. 2d. In particular, in the embodiment shown in FIG. 2c, the decompressor 240 of FIG. 1b again includes a combiner 245 for performing addition of the different harmonic components from the different subbands to then obtain an overall representation of the harmonic components, which are then converted into the time domain by the converter 244. Thus, the input signals in the combiner 245 are in the harmonic component spectral domain, while the output of the combiner 345 represents a representation in the harmonic component domain, from which then a conversion into the time domain is obtained by the converter 244.

In the alternative embodiment shown in FIG. 2b, the individual harmonic components for each subband are first converted into the spectral domain by different converters 241a, 241b, 241c, such that the output signals of blocks 241a, 241b, 241c correspond to the output signals of blocks 140a, 140b, 140c of FIG. 2a or FIG. 2b. Then, these subband signals are processed in a downstream synthesis filter bank which can also comprise an upsampling function, in the case of downsampling on the encoder side (block 100c of FIG. 2b). Then, the synthesis filter bank represents the combiner function of the decoder 240 of FIG. 1b. Thus, the decompressed sound field representation, which can be used for auralization as will be presented below, is present at the output of the synthesis filter bank.

FIG. 1f shows an example for the decomposition of impulse responses into harmonic components of different orders. The late sections are not spectrally decomposed but totally converted with the zeroth order. The early sections of the impulse responses are spectrally decomposed. The lowest band is, for example, processed with the first order while the next band is already processed with the fifth order and the last band, since the same is most important for directional/spatial perception, is processed with the highest order, i.e., in this example with the order 14.

FIG. 3a shows the entire encoder/decoder scheme or the entire compressor/decompressor scheme of the present invention.

In particular, in the embodiment shown in FIG. 3a, the compressor does not only shown the functionalities of FIG. 1a indicated by 1 or PENC but also a decoder PDEC2 which can be configured as in FIG. 1b. Above that, the compressor also includes a control CTRL4 configured to compare decompressed sound field data obtained by the decoder 2 with original sound field data by considering a psychoacoustic model, such as the model PEAQ standardized by ITU.

Thereupon, the control 4 generates optimized parameters for the division such as the temporal division, frequency division in the filter bank or optimized parameters for the orders in the individual converters for the different portions of the sound field data when these converters are configured in a controllable manner.

Control parameters, such as division information, filter bank parameters or orders can then be transmitted together with a bit stream comprising the harmonic components to a decoder or decompressor illustrated by 2 in FIG. 3a. Thus, the compressor 11 consists of the control block CTRL4 for the codec control as well as a parameter encoder PENC 1 and the parameter decoder PDEC2. The inputs 10 are data from microphone array measurements. The control block 4 initializes the encoder 1 and provides all parameters for encoding the array data. In the PENC block 1, the data are processed according to the described method of hearing-dependent division in the time and frequency domain and are provided for data transmission.

FIG. 3b shows the scheme of data encoding and decoding. The input data 10 are first decomposed by divider 100a into an early 101 and a late sound field 102. By means of a small n band filter bank 100b, the early sound field 101 is decomposed into its spectral components f₁ . . . fₙ, each decomposed with an order of the spherical harmonics (x order SHD=Spherical Harmonics Decomposition) adapted to human hearing. This decomposition into spherical harmonics represents an embodiment, wherein, however, any sound field decomposition generating harmonic components can be used. Since the decomposition into spherical harmonic components necessitates computing times of varying durations in each band according to the order, it is advantageous to correct the time offsets in a delay line with delay blocks 306, 304. Thus, the frequency domain is reconstructed in the reconstruction block 245, also referred to as combiner, and combined again with the late sound field in the further combiner 243, after the same has been computed with a perceptually low order.

The control block CTRL 4 of FIG. 3a includes a room acoustic analysis module and a psychoacoustic module. Here, the control block analyses both the input data 10 and the output data of the decoder 2 of FIG. 3a in order to adaptively adapt the encoding parameters also referred to as side information 300 in FIG. 3a or which are provided directly to the encoder PENC1 in the compressor 11. From the input signals 10, room acoustic parameters are extracted, which provide the initial parameters of the encoding with the parameters of the used array configuration. The same include both the time of separation between early and late sound field, also referred to as mixing time, and the parameters for the filter bank, such as respective orders of the spherical harmonics. The output, which can be, for example, in the form of binaural impulse responses, as it is output by the combiner 243, is guided into a psychoacoustic module with an auditory model which evaluates the quality and adapts the encoding parameters accordingly. Alternatively, the concept can also operate with static parameters. The control module CTRL4 as well as the PEDC module 2 on the encoder or compressor side 11 can then be omitted.

The invention is advantageous in that data and computing effort when processing and transmitting circular and spherical array data in dependence on the human hearing are reduced. It is further advantageous that the data processed in that manner can be integrated in existing compression methods and hence allow additional data reduction. This is advantageous in band-limited transmission systems such as for mobile terminal devices. A further advantage is the possible real time processing of data in the spherical harmonic domain even at high orders. The present invention can be applied in many fields, in particular in fields where the acoustic sound field is represented by means of cylindrical or spherical harmonics. This is performed, e.g., in sound field analysis by means of circular or spherical arrays. When the analyzed sound field is to be auralized, concept of the present invention can be used. In devices for simulating rooms, data bases for storing existing rooms are used. Here, the inventive concept allows space-saving and high quality storage. Reproduction methods, which are based on spherical area functions, exist, such as higher order ambisonics or binaural synthesis. Here, the present invention provides a reduction of computing time and data effort. This can be particularly advantageous with respect to data transmission, e.g., in teleconference systems.

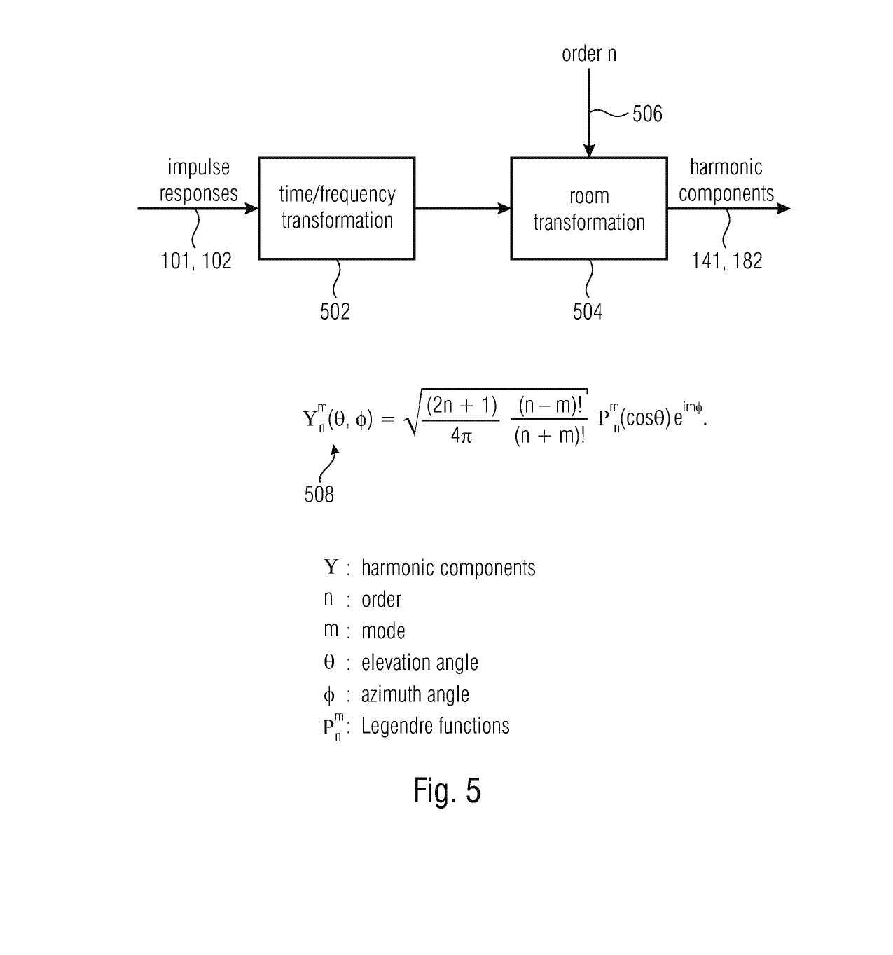

FIG. 5 shows an implementation of a converter 140 or 180 with adjustable order or at least with varying order which can also be non-adjustable.

The converter includes a time-frequency transformation block 502 and a downstream room transformation block 504. The room transformation block 504 is configured to operate according to the computation rule 508. In the computation rule, n is the order. Depending on the order, the computation rule 508 is solved only once when the order is zero, or is solved more often when the order is up to the order 5 or, in the above described embodiment, up to the order of 14. In particular, the time-frequency transformation element 502 is configured to transform the impulse responses on the input lines 101, 102 into the frequency domain, wherein advantageously the fast Fourier transformation is used. Further, only the unilateral spectrum is forwarded to reduce the computing effort. Then, spatial Fourier transformation is performed in the block room transformation 504, as described in the reference book Fourier Acoustics, Sound Radiation and Nearfield Acoustical Holography, Academic Press, 1999 by Earl G. Williams. Advantageously, the room transformation 504 is optimized for sound field analysis and provides at the same time a high numerical accuracy and fast computation velocity.

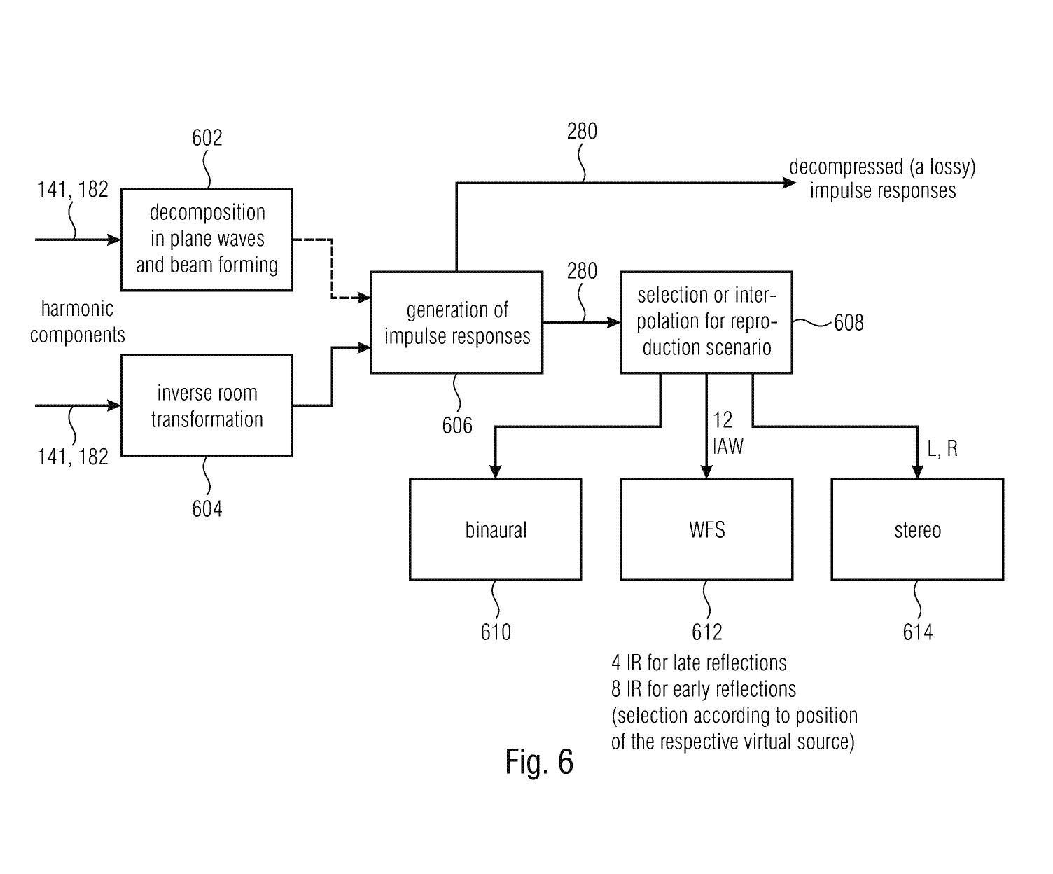

FIG. 6 shows the implementation of a converter from the harmonic components domain into the time domain, wherein, as an alternative, a processor for decomposing into plane waves and beamforming 602 is represented, as an alternative to an inverse room transformation implementation 604. The output signals of both blocks 602, 604 can alternatively be fed into a block 606 for generating impulse responses. The inverse room transformation 604 is configured to reverse the forward transformation in block 504. Alternatively, the decomposition into plane waves and the beam forming in block 606 have the effect that a great amount of decomposition directions can be processed uniformly, which is favorable for fast processing, in particular for visualization or auralization. Block 602 obtains radial filter coefficients, as well as, depending on the implementation, additional beamforming coefficients. The same can either have a constant directionality or can be frequency-dependent. Alternative input signals into block 602 can be modal radial filters, and in particular for spherical arrays or different configurations, such as an open sphere with omnidirectional microphones, an open sphere with cardioid microphones and a rigid sphere with omnidirectional microphones. The block 606 for generating impulse responses generates impulse responses or time domain signals from data either of block 602 or of block 604. This block recombines in particular the above omitted negative portions of the spectrum, performs fast inverse Fourier transformation and allows resampling or sample rate conversion to the original sample rate if the input signal has been downsampled at some place. Further, a window option can be used.

Details concerning the functionality of blocks 502, 504, 602, 604, 606 are described in the expert publication “SofiA Sound Field Analysis Toolbox” by Bernschütz et al., ICSA—International Conference on Spatial Audio, Detmold, 10 to 13 Nov. 2011, wherein this expert publication is incorporated herein by reference in its entirety.

The block 606 can further be configured to output the complete set of decompressed impulse responses, e.g. the lossy impulse responses, wherein block 608 would then again output, for example 350 impulse responses. Depending on the auralization, however, it is advantageous to output merely the impulse responses finally necessitated for reproduction, which can be performed by block 608 that provides a selection or interpolation for a specific reproduction scenario. If, for example, stereo reproduction is intended, as illustrated in block 616, depending on the positioning of the two stereo loudspeakers, that impulse response which respectively corresponds to the spatial direction of the respective stereo loudspeaker is selected from the 350, for example reproduced impulse responses. Then, with this impulse response, a prefilter of the respective loudspeaker is adjusted, such that the prefilter has a filter characteristic corresponding to that impulse response. Then, an audio signal to be reproduced is guided to the two loudspeakers via the respective prefilters and reproduced in order to finally generate the desired spatial impression for stereo auralization.

If, among the available impulse responses, an impulse response exists in a specific direction in which a loudspeaker is disposed in the actual reproduction scenario, advantageously the two or three closest impulse responses are used and interpolation is performed.

In an alternative embodiment, where reproduction or auralization takes place by wavefield synthesis 612, it is advantageous to perform reproduction of early and late reflections via virtual sources, such as illustrated in detail in the PhD document “Spatial Sound Design based on Measured Room Impulse Responses” by Frank Melchior, TU Delft of the year 2011, wherein this expert publication is also incorporated herein by reference in its entirety.

In particular in wavefield synthesis reproduction 612, the reflections of a source are reproduced by four impulse responses at specific positions for the early reflections and eight impulse responses at specific positions for the late reflections. The selection block 608 then selects the 12 impulse responses for the 12 virtual positions. Thereupon, these impulse responses are supplied, together with the allocated positions, to a wavefield synthesis renderer, which can be disposed in block 612, and the wavefield synthesis renderer computes the loudspeaker signals for the actually existing loudspeakers by using these impulse responses, so that the same map the respective virtual sources. Thus, for each loudspeaker in the wavefield synthesis reproduction system, an individual prefilter is computed, which then filters a finally to be reproduced audio signal, before the same is output by the loudspeaker in order to obtain a respective reproduction with high-quality room effects.

An alternative implementation of the present invention is the generation of headphone signal, i.e. a binaural application where the spatial impression of the area is to be generated via the headphone reproduction.

Although mainly impulse responses have been illustrated as sound field data above, any other sound field data, for example sound field data according to amount and vector, i.e. with regard to, e.g., sound pressure and sound velocity can also be used at specific positions in the room. These sound field data can also be divided into more important and less important portions with regard to human directional perception and can be converted into harmonic components. The sound field data can also include any type of impulse responses, such as head-related transfer functions (HRTF) functions or binaural room impulse responses (BRIR) functions or impulse responses, each from a discrete point to a predetermined position in the area.

Advantageously, a room is sampled with a spherical array. Then, the sound field exists as a set of impulse responses. In the time domain, the sound field is decomposed in its early and late portions. Subsequently, both parts are decomposed in their spherical or cylindrical harmonic components. Since the relative direction information exists in the early sound field, a higher order of spherical harmonics is computed compared to the late sound field, which is sufficient for a low order. The early part is relatively short, for example 100 ms and is represented accurately, i.e. with many harmonic components, while the late part is, for example 100 ms to 2 s or 10 s long. This late part, however, is represented with less or only a single harmonic component.

A further data reduction results due to division of the early sound field into individual bands prior to the representation as spherical harmonics. For this, after separation into early and late sound field in the time domain, the early sound field is decomposed into its spectral portions by means of a filterbank. By subsampling the individual frequency bands, data reduction is obtained, which significantly accelerates the computation of the harmonic components. Additionally, for each frequency band, an early order perceptionally sufficient in dependence on a human directional perception is used. Thus, for low frequency bands, where the human directional perception is low, low orders or for the lowest frequency band even the order of zero would be sufficient, while in high bands higher orders up to the maximum useful order with regard to the accuracy of the measured sound field are necessitated. On the decoder or decompressor side, the complete spectrum is reconstructed. Subsequently, early or late sound fields are combined again. The data are now available for auralization.

Although some aspects have been described in the context of an apparatus, it is clear that these aspects also represent a description of the corresponding method, such that a block or device of an apparatus also corresponds to a respective method step or a feature of a method step. Analogously, aspects described in the context of a method step also represent a description of a corresponding block or item or feature of a corresponding apparatus. Some or all of the method steps may be executed by (or using) a hardware apparatus, like, for example, a microprocessor, a programmable computer or an electronic circuit. In some embodiments, some or several of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may for example be stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive methods is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer a computer program for performing one of the methods described herein to a receiver. The transmission can be performed electronically or optically. The receiver may, for example, be a computer, a mobile device, a memory device or the like. The apparatus or system may, for example, comprise a file server for transferring the computer program to the receiver.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. Apparatus for compressing sound field data of an area, comprising:
a divider for dividing the sound field data into a first portion and into a second portion; and
a converter for converting the first portion and the second portion into harmonic components, wherein the converter is configured to convert the second portion into one or several harmonic components of a second order, and to convert the first portion into harmonic components of a first order, wherein the first order is higher than the second order, to acquire the compressed sound field data,
wherein the divider is configured to perform spectral division and comprises a filterbank for filtering at least part of the sound field data for acquiring sound field data in different filterbank channels, and
wherein the converter is configured to compute, for a subband signal from a first filterbank channel, which represents the first portion, of the different filterbank channels, the harmonic components of the first order, and to compute, for a subband signal from a second filterbank channel, which represents the second portion, of the different filterbank channels, the harmonic components of the second order, wherein a center frequency of the first filterbank channel is higher than a center frequency of the second filterbank channel.

2. Apparatus according to claim 1,
wherein the converter is configured to compute the harmonic components of the first order, which is higher than the second order, for the first portion, which is more important for directional perception of the human hearing than the second portion.

3. Apparatus according to claim 1,
wherein the divider is configured to divide the sound field data into the first portion comprising first reflections in the area and into the second portion comprising second reflections in the area, wherein the second reflections occur later in time than the first reflections.

4. Apparatus according to claim 1,
wherein the divider is configured to divide the sound field data into the first portion comprising first reflections in the area and into the second portion comprising second reflections in the area, wherein the second reflections occur later in time than the first reflections, and wherein the divider is further configured to decompose the first portion into spectral portions and to convert the spectral portions each into one or several harmonic components of different orders, wherein an order for a spectral portion with a higher frequency band is higher than an order for a spectral portion in a lower frequency band.

5. Apparatus according to claim 1, further comprising an output interface for providing the one or several harmonic components of the second order and the harmonic components of the first order together with side information comprising an indication on the first order or the second order for transmission and storage.

6. Apparatus according to claim 1,
wherein the sound field data describe a three-dimensional area and the converter is configured to compute cylindrical harmonic components as the harmonic components, or
wherein the sound field data describe a three-dimensional area and the converter is configured to compute spherical harmonic components as the harmonic components.

7. Apparatus according to claim 1,
wherein the sound field data exist as a first number of discrete signals,
wherein the converter for the first portion and the second portion provides a second total number of harmonic components, and
wherein the second total number of harmonic components is smaller than the first number of discrete signals.

8. Apparatus according to claim 1,
wherein the divider is configured to use, as sound field data, a plurality of different impulse responses that are allocated to different positions in the area.

9. Apparatus according to claim 8,
wherein the impulse responses are head-related transfer functions or binaural room impulse responses functions or impulse responses of a respective discrete point in the area to a predetermined position in the area.

10. Apparatus according to claim 1, further comprising:
a decoder for decompressing the compressed sound field data by using a combination of the first and second portions and by using a conversion from a harmonic component representation into a time domain representation for acquiring a decompressed representation; and
a control for controlling the divider or the converter with respect to the first or second order, wherein the control is configured to compare, by using a psychoacoustic module, the decompressed sound field data with the sound field data and to control the divider or the converter by using the comparison.

11. Apparatus according to claim 10,
wherein the decoder is configured to convert the harmonic components of the second order and the harmonic components of the first order and to then perform a combination of the converted harmonic components, or
wherein the decoder is configured to combine the harmonic components of the second order and the harmonic components of the first order and to convert a result of the combination in the combiner from a harmonic component domain into the time domain.

12. Apparatus according to claim 10,
wherein the decoder is configured to convert harmonic components of different spectral portions with different orders,
to compensate different processing times for different spectral portions, and
to combine spectral portions of the first portion converted into a time domain with the spectral components of the second portion converted into the time domain by serially arranging the same.

13. Apparatus for decompressing compressed sound field data comprising first harmonic components up to a first order and one or several second harmonic components up to a second order, wherein the first order is higher than the second order, comprising:
an input interface for acquiring the compressed sound field data; and
a processor for processing the first harmonic components and the second harmonic components by using a combination of the first and the second portion and by using a conversion of a harmonic component representation into a time domain representation to acquire a decompressed illustration, wherein the first portion is represented by the first harmonic components and the second portion by the second harmonic components,
wherein the first harmonic components of the first order represent a first spectral domain, and the one or the several harmonic components of the second order represent a different spectral domain,
wherein the processor is configured to convert the harmonic components of the first order into the spectral domain and to convert the one or the several second harmonic components of the second order into the spectral domain, and to combine the converted harmonic components by means of a synthesis filterbank to acquire a representation of sound field data in the time domain.

14. Apparatus according to claim 13, wherein the processor comprises:
a combiner for combining the first harmonic components and the second harmonic components to acquire combined harmonic components; and
a converter for converting the combined harmonic components into the time domain.

15. Apparatus according to claim 13, wherein the processor comprises:
a converter for converting the first harmonic components and the second harmonic components into the time domain; and
a combiner for combining the harmonic components converted into the time domain for acquiring the decompressed sound field data.

16. Apparatus according to claim 13,
wherein the processor is configured to acquire information on a reproduction arrangement, and
wherein the processor is configured to compute the decompressed sound field data and to select, based on the information on the reproduction arrangement, part of the sound field data of the decompressed sound field data for reproduction purposes, or
wherein the processor is configured to compute only a part of the decompressed sound field data necessitated for the reproduction arrangement.

17. Apparatus according to claim 13,
wherein the first harmonic components of the first order represent early reflections of the area and the second harmonic components of the second order represent late reflections of the area, and
wherein the processor is configured to add the first harmonic components and the second harmonic components and to convert a result of the addition into the time domain for acquiring the decompressed sound field data.

18. Apparatus according to claim 13,
wherein the processor is configured to perform, for the conversion, an inverse room transformation and an inverse Fourier transformation.

19. Method for compressing sound field data of an area, comprising:
dividing the sound field data into a first portion and into a second portion, and
converting the first portion and the second portion into harmonic components,
wherein the second portion is converted into one or several harmonic components of a second order, and wherein the first portion is converted into harmonic components of a first order, wherein the first order is higher than the second order, to acquire the compressed sound field data,
wherein dividing comprises spectral division by filtering with a filterbank for filtering at least part of the sound field data for acquiring sound field data in different filterbank channels, and
wherein converting represents a computation of the harmonic components of the first order for a subband signal from a first filterbank channel, which represents the first portion, of the different filterbank channels, and a computation of the harmonic components of the second order for a subband signal from a second filterbank channel, which represents the second portion, of the different filterbank channels, wherein a center frequency of the first filterbank channel is higher than a center frequency of the second filterbank channel.

20. Method for decompressing compressed sound field data comprising first harmonic components up to a first order and one or several second harmonic components up to a second order, wherein the first order is higher than the second order, comprising:
acquiring the compressed sound field data; and
processing the first harmonic components and the second harmonic components by using a combination of the first and second portions and by using a conversion from a harmonic component representation into a time domain representation to acquire a decompressed representation, wherein the first portion is represented by the first harmonic components and the second portion by the second harmonic components,
wherein the first harmonic components of the first order represent a first spectral domain, and the one or the several harmonic components of the second order represent a different spectral domain,
wherein processing comprises converting the first harmonic components of the first order into the spectral domain and converting the one or the several second harmonic components of the second order into the spectral domain and combining the converted harmonic components by means of a synthesis filterbank to acquire a representation of sound field data in the time domain.

21. A non-transitory digital storage medium having a computer program stored thereon to perform the method for compressing sound field data of an area, the method comprising:
dividing the sound field data into a first portion and into a second portion, and
converting the first portion and the second portion into harmonic components, wherein the second portion is converted into one or several harmonic components of a second order, and wherein the first portion is converted into harmonic components of a first order, wherein the first order is higher than the second order, to acquire the compressed sound field data,
wherein dividing comprises spectral division by filtering with a filterbank for filtering at least part of the sound field data for acquiring sound field data in different filterbank channels, and
wherein converting represents a computation of the harmonic components of the first order for a subband signal from a first filterbank channel, which represents the first portion, of the different filterbank channels, and a computation of the harmonic components of the second order for a subband signal from a second filterbank channel, which represents the second portion, of the different filterbank channels, wherein a center frequency of the first filterbank channel is higher than a center frequency of the second filterbank channel,
when said computer program is run by a computer.

22. A non-transitory digital storage medium having a computer program stored thereon to perform the method for decompressing compressed sound field data comprising first harmonic components up to a first order and one or several second harmonic components up to a second order, wherein the first order is higher than the second order, the method comprising:
acquiring the compressed sound field data; and
processing the first harmonic components and the second harmonic components by using a combination of the first and second portions and by using a conversion from a harmonic component representation into a time domain representation to acquire a decompressed representation, wherein the first portion is represented by the first harmonic components and the second portion by the second harmonic components,
wherein the first harmonic components of the first order represent a first spectral domain, and the one or the several harmonic components of the second order represent a different spectral domain,
wherein processing comprises converting the first harmonic components of the first order into the spectral domain and converting the one or the several second harmonic components of the second order into the spectral domain and combining the converted harmonic components by means of a synthesis filterbank to acquire a representation of sound field data in the time domain,
when said computer program is run by a computer.
